(19) United States
(12) Patent Application Publication
(10) Pub. No.: US 2026/0036933 A1
(43) Pub. Date: Feb. 5, 2026

(54) IMAGE FORMING APPARATUS, CONTROL METHOD FOR THE SAME, AND STORAGE MEDIUM

(71) Applicant: CANON KABUSHIKI KAISHA, Tokyo (JP)

(72) Inventor: HIDESHI ICHIMI, Ibaraki (JP)

(21) Appl. No.: 19/262,407

(22) Filed: Jul. 8, 2025

(30) Foreign Application Priority Data
Jul. 30, 2024 (JP) 2024-123433

(51) Int. Cl. G03G 15/00; G03G 15/16; H04N 1/00; H04N 1/23

(52) U.S. Cl. CPC G03G 15/502; G03G 15/1675; G03G 15/5029; G03G 15/5095; G03G 15/6558; H04N 1/00413; H04N 1/00482; H04N 1/00811; H04N 1/2323; H04N 1/2338; G03G 2215/00616; G03G 2215/00751

(57) ABSTRACT

The image forming apparatus comprising: one or more memory devices that store a set of instructions; and one or more processors that execute the set of instructions to: output a first screen on which a print sheet can be set, and a second screen for setting a parameter for controlling driving of an image forming apparatus corresponding to a type of the print sheet and determine whether or not a first object for transitioning from the first screen to the second screen is to be included in the first screen, wherein it is determined that the first object is to be included in the first screen if the print sheet for which the parameter has already been set is present.

### BACKGROUND

### Field of the Technology

The present disclosure relates to an image forming apparatus, a control method for the same, and a storage medium.

### Description of the Related Art

Specifying the type of paper fed in a print job from a paper type database (media library) stored in advance in an image forming apparatus is known. By using print control parameters for the specified type of paper in image formation control, a high-quality finished product can be obtained. Also, in order to accommodate a wide variety of types of paper, an image forming apparatus is known that can copy pre-stored types of paper and register a user-defined paper for which the user can change the print control parameters for the type of paper as appropriate, in a media library.

Japanese Patent Laid-Open No. 2022-26815 proposes a technology in which a paper type detection sensor (media sensor) that measures a feature amount of paper such as the surface properties and basis weight of the paper is provided on a paper conveying path of an image forming apparatus, and the type of paper that is the copy source of the user-defined paper is measured and specified using the media sensor.

When a user selects a pre-stored type of paper and creates a copied user-defined paper, or when a user uses a media sensor to specify a type of paper and creates a copied user-defined paper, the user must adjust the print control parameters after creating the user-defined paper. However, although adjusting the print control parameters is not a problem for a knowledgeable user, it is difficult for an office user who does not usually have an awareness thereof.

### SUMMARY

The present disclosure enables the realization of a novel mechanism that allows a user to easily adjust a print control parameter.

One aspect of the present disclosure provides an image forming apparatus comprising: one or more memory devices that store a set of instructions; and one or more processors that execute the set of instructions to: output a first screen on which a print sheet can be set, and a second screen for setting a parameter for controlling driving of an image forming apparatus corresponding to a type of the print sheet; and determine whether or not a first object for transitioning from the first screen to the second screen is to be included in the first screen, wherein it is determined that the first object is to be included in the first screen if the print sheet for which the parameter has already been set is present.

Another aspect of the present disclosure provides a control method for an image forming apparatus, comprising: outputting a first screen on which a print sheet can be set, and a second screen for setting a parameter for controlling driving of an image forming apparatus corresponding to a type of the print sheet; and determining whether or not a first object for transitioning from the first screen to the second screen is to be included in the first screen, wherein it is determined that the first object is to be included in the first screen if the print sheet for which the parameter has already been set is present.

Still another aspect of the present disclosure provides a non-transitory computer-readable storage medium storing a program for causing a computer to execute each step of a control method for an image forming apparatus, the control method comprising: outputting a first screen on which a print sheet can be set, and a second screen for setting a parameter for controlling driving of an image forming apparatus corresponding to a type of the print sheet; and determining whether or not a first object for transitioning from the first screen to the second screen is to be included in the first screen, wherein it is determined that the first object is to be included in the first screen if the print sheet for which the parameter has already been set is present.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image forming apparatus according to an embodiment.

FIG. 2 is a block diagram of an image forming apparatus according to an embodiment.

FIG. 3 is a schematic diagram of a fixing device according to an embodiment.

FIG. 4 is a schematic diagram of a media sensor according to an embodiment.

FIGS. 5A to 5E show display screens of an image forming apparatus according to an embodiment of the present disclosure.

FIGS. 6A to 6H show display screens of an image forming apparatus according to an embodiment of the present disclosure.

FIG. 7 is a flowchart of control processing in the image forming apparatus according to one embodiment.

FIGS. 8A to 8E show display screens of an image forming apparatus according to an embodiment of the present disclosure.

FIG. 9 is a flowchart of control processing in the image forming apparatus according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the ease that all such features are required, and multiple such features may be combined as appropriate. Furthermore, in the attached drawings, the same reference numerals are given to the same or similar configurations, and redundant description thereof is omitted.

In this specification, the term “image forming apparatus” broadly includes apparatuses that form (record) images on recording materials (recording media), such as single-function printers, copying machines, multi-function printers, and commercial printing machines. Also, the recording apparatus may be a system (image forming system) in which a recording apparatus main body that forms an image on a recording material is connected to devices such as a sheet processing apparatus and a sheet feeding apparatus.

### Device Configuration

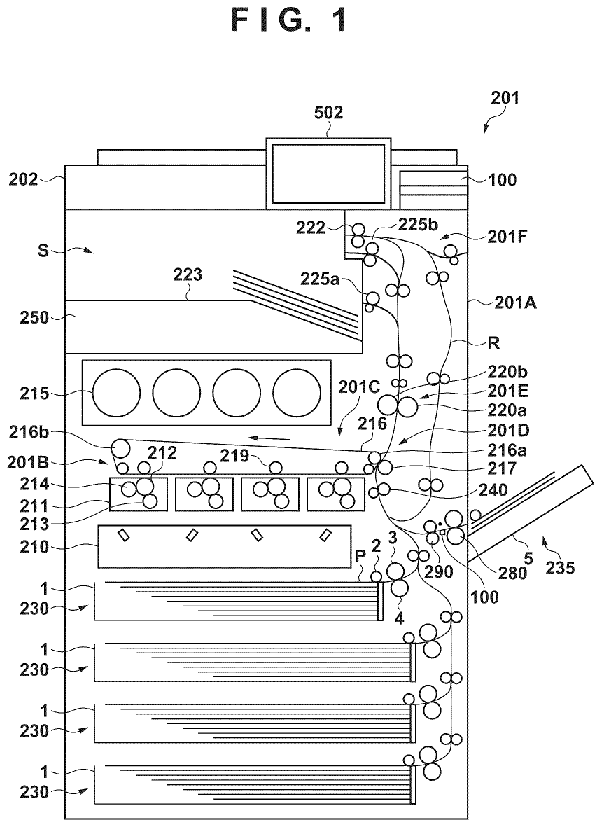

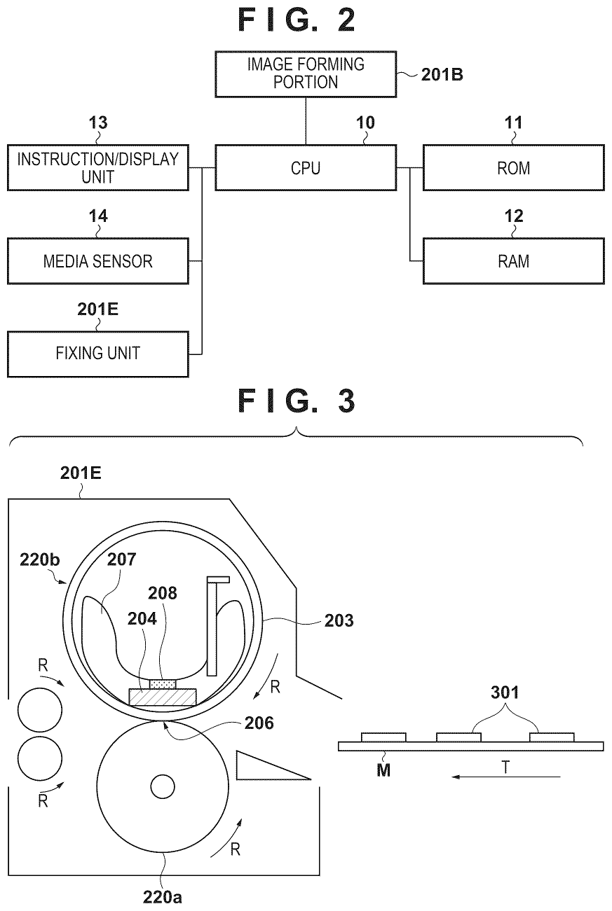

The basic configuration and operation of the image forming apparatus 201 of this embodiment will be described with reference to FIGS. 1 and 2. The image forming apparatus 201 includes a CPU 10, a ROM 11, a RAM 12, an instruction/display unit 13, a media sensor 14, an image forming unit 201B, and a fixing unit 201E. The CPU 10 shown in FIG. 2 is a control unit that performs overall control of the image forming apparatus 201. More specifically, the CPU 10 controls, for example, switching of the display screen. In addition, for example, when the user changes the print control parameters corresponding to the type of paper, the CPU 10 additionally stores the changed print control parameters in the first storage region of the RAM 12 in association with the type of paper. The ROM 11 stores a control program, initial values of various settings, and the like. The CPU 10 executes a control program read from the ROM 11 to realize the image formation procedure and the procedures of each flowchart, which will be described later. Under the control of the CPU 10, the RAM 12 stores various types of information. In addition, print control parameters for each type of paper are stored in the first storage region of the RAM 12. Note that the RAM 12 may be a rewritable memory that does not require a memory holding operation. In addition, a hard disk drive (HDD) may be provided, and the information stored in the RAM 12 may be stored in the HDD.

The instruction/display unit 13 includes an operation panel 205, and accepts operations on the operation panel 205 (an example of “accepting”). For example, when an instruction to start a print operation or the like is input, the instruction information is sent to the CPU 10. Note that the operation panel 205 includes, for example, buttons and a touch panel display that can display an operation screen and allow input to the operation screen. In addition, instruction information to start a print operation or the like may be input by the user operating the instruction/display unit 13, or may be input from an external device such as a personal computer, a tablet terminal, or a smartphone connected via a network or the like (not shown).

When instruction information to start a print operation or the like is input, the CPU 10 drives and controls a paper feeding and conveying motor (not shown) in accordance with the instruction information, thereby feeding and conveying a sheet of paper. In addition, the CPU 10 controls image formation (printing) by the image forming unit 201B by setting print control parameters for the image forming unit 201B. The image forming unit 201B performs printing on a sheet of paper based on the print control parameters set by the CPU 10.

As shown in FIG. 1, an image forming apparatus main body 201A of an image forming apparatus 201 includes an image forming unit 201B that forms an image on a sheet of paper. In addition, an image reading apparatus 202 is disposed substantially horizontally above the image forming apparatus main body 201A. Between the image reading apparatus 202 and the image forming apparatus main body 201A, a discharge space S for discharging sheets of paper is formed. In addition, an operation panel 205 for accepting operations from a user is provided on the upper portion of the image forming apparatus 201.

The image forming apparatus main body 201A includes a cassette feeding portion 230. The cassette feeding portion 230 feeds a sheet P from a feeding cassette 1 that is a sheet storage portion for storing the sheet P. The cassette feeding portion 230 includes a pickup roller 2 that is a sheet feeding portion, and a separation portion that includes a feed roller 3 and a retard roller 4 for separating the sheet P fed from the pickup roller 2. The image forming apparatus main body 201A also includes a manual feeding portion 235. The manual feeding portion 235 feeds the sheet P from the manual feed tray 5 that holds the sheet P. Similarly to the cassette feeding portion 230, the manual feeding portion 235 includes a sheet feeding portion and a separation portion.

The image forming unit 201B, which is an image forming portion, is a four-drum full-color type and includes a laser scanner 210 and four process cartridges 211 that form toner images of four colors: yellow (Y), magenta (M), cyan (C), and black (K). Here, each process cartridge 211 includes a photosensitive drum 212, a charger 213 that is a charging portion, and a developer 214 that is a developing portion. The image forming unit 201B also includes a secondary transfer portion 201D disposed above the process cartridge 211, and a fixing unit 201E. Note that the image forming apparatus main body 201A includes a toner cartridge 215 that supplies toner to the developer 214.

The secondary transfer portion 201D includes a transfer belt 216 that is wound around a drive roller 216a and a tension roller 216b. Note that a primary transfer roller 219 that comes into contact with the transfer belt 216 at a position facing the photosensitive drum 212 is provided on the inner side of the transfer belt 216. Here, the transfer belt 216 is rotated in the direction of the arrow by a drive roller 216a driven by a drive unit (not shown). In addition, a secondary transfer roller 217 for transferring a color image formed on the transfer belt 216 onto the sheet P is provided at a position facing the drive roller 216a of the secondary transfer portion 201D. Furthermore, a fixing unit 201E is disposed above the secondary transfer roller 217, and a first discharge roller pair 225a, a second discharge roller pair 225b, and a double-sided reversing unit 201F are disposed above and to the left of the fixing unit 201E. The double-sided reversing unit 201F is provided with a reversing roller pair 222 and a re-conveyance path R for conveying the sheet P having an image formed on one side thereof to the image forming unit 201B again.

### Operation of Image Forming Apparatus

Next, the image forming operation of the image forming apparatus 201 will be described. First, when the image forming apparatus 201 receives image data of an original document to be printed, the image information is subjected to image processing, converted into an electrical signal, and transmitted to the laser scanner 210 of the image forming unit 201B. In the image forming unit 201B, the surface of the photosensitive drum 212, which has been uniformly charged to a predetermined polarity and potential by the charger 213, is sequentially exposed to a laser. As a result, yellow, magenta, cyan, and black electrostatic latent images are sequentially formed on the photosensitive drums of the process cartridges 211, respectively.

Thereafter, this electrostatic latent image is developed and made visible with toner of each color, and the toner images of the respective colors on the respective photosensitive drums are sequentially transferred to the transfer belt 216 in a superimposed state by a primary transfer bias applied to the primary transfer roller 219. As a result, a toner image is formed on the transfer belt 216. In parallel with this toner image forming operation, sheets P are conveyed one by one by the cassette feeding portion 230 to the pair of registration rollers 240, and the skew of the sheets P is corrected by the pair of registration rollers 240. After the skew is corrected, the sheet P is conveyed by a pair of registration rollers 240 to a secondary transfer portion 201D. In the secondary transfer portion 201D, the toner images are transferred onto the sheet P all at once by a secondary transfer bias applied to the secondary transfer roller 217.

Next, the sheet Ponto which the toner image has been transferred is conveyed to the fixing unit 201E. In a roller nip portion formed by a pressure roller 220a and a fixing heating roller 220b, the toners of the respective colors are melted and mixed by heat and pressure, and are fixed onto the sheet P as a color image. At this time, the adhesive force of the molten toner causes the sheet P to stick to the fixing heating roller 220b. If the stiffness (rigidity) of the sheet P is weak, it will be taken up by the rotating fixing heating roller 220b as-is. In view of this, a separation plate for separating the sheet is provided downstream of the fixing heating roller 220b.

Thereafter, the sheet P onto which the image has been fixed is discharged into the discharge space S by a first discharge roller pair 225a and a second discharge roller pair 225b provided downstream of the fixing unit 201E, and is stacked on a stacking unit 223 protruding from the bottom surface of the discharge space S. Note that when images are formed on both sides of the sheet P, after the images are fixed, the sheet P is conveyed to the re-conveyance path R by the reversing roller pair 222 and conveyed again to the image forming unit 201B.

Returning to FIG. 2, the control blocks controlled by the CPU 10 of the image forming apparatus 201 will be described. The image forming apparatus 201 includes the media sensor 14 on the paper conveying path. The media sensor 14 is a paper type detection sensor 100 that detects the type of paper fed via the paper conveying path. The media sensor 14 detects the surface properties and thickness of the paper being conveyed. Then, the CPU 10 distinguishes the type of paper based on the detection result. Note that the media sensor 14 detects the surface property, thickness, and the like of the paper, and the CPU 10 distinguishes the type of paper based on the detection result, which is also expressed as the media sensor 14 detecting or distinguishing the type of paper.

### Description of Fixing Unit

The fixing unit 201E will be described in detail with reference to FIG. 3. The fixing unit 201E is an assembly including the fixing heating roller 220b, the pressure roller 220a, and the like. The fixing heating roller 220b also includes a heater holder 207, a fixing heater 204 disposed on the lower surface of the heater holder 207 along the longitudinal direction of the heater holder (perpendicular to the drawing), and a fixing film 203 that is an elastic layer. Note that each arrow R in FIG. 3 indicates the direction of rotation. An arrow T in FIG. 3 indicates the direction of movement of the paper M on which toner 301 has been placed.

The pressure roller 220a is disposed such that both ends of its core metal are rotatably supported by bearings between the side plates of the fixing device. The fixing unit 201E is arranged parallel to the pressure roller 220a with the fixing heater 204 side in an orientation in contact with the pressure roller 220a, and both end sides of the heater holder 207 are pressed with a predetermined pressure by a biasing mechanism (not shown). As a result, the surface of the fixing heater 204 is pressed against the elasticity of the pressure roller 220a with the fixing film 203 interposed therebetween, forming a fixing nip portion 206 of a predetermined width.

The pressure roller 220a is driven to rotate at a predetermined peripheral speed in the counterclockwise direction indicated by an arrow R by a drive mechanism (not shown). The fixing heater 204 is obtained by forming a resistive heating clement on a ceramic substrate. A temperature detection sensor 208 is in contact with the fixing heater 204. The CPU 10 detects the temperature of the fixing heater 204 from the output of the temperature detection sensor 208, and controls the power supplied to the fixing heater 204 such that the temperature of the fixing heater 204 reaches a predetermined target temperature. The target temperature of the fixing heater 204 is determined based on the type of paper that is to pass through and the environmental temperature. The CPU 10 determines the target temperature of the fixing heater 204 using the paper type information set from the instruction/display unit 13 or the paper type information detected by the media sensor 14. As described above, the target temperature of the fixing unit 201E is set to a lower temperature for thin paper compared to plain paper, and to a higher temperature for thick paper.

### Description of Media Sensor

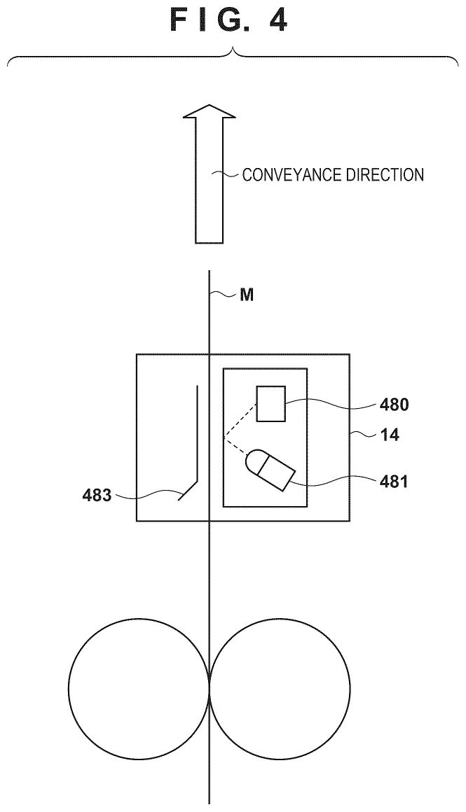

Next, the media sensor 14 will be described in detail with reference to FIG. 4. Inside the media sensor 14, an LED 481 (an example of a “light emitting unit” in the present disclosure) is arranged as a light emitting clement, and a photodiode 480 (an example of a “light receiving unit” in the present disclosure) is arranged as a light receiving clement. The light emitted by the LED 481 is reflected by a predetermined reflection region, and the photodiode 480 can detect the amount of the reflected light. In addition, the media sensor 14 is provided with a guide portion 483 for guiding the paper M.

The CPU 10 receives an input signal from the photodiode 480 as the output value of the media sensor 14. The CPU 10 can distinguish the type of paper that is to pass therethrough according to the difference in output value caused by the surface property and thickness of each sheet of paper. Then, the CPU 10 optimally controls the image forming speed and the target temperature of the fixing unit 201E in accordance with the detected type of paper. As described above, due the CPU 10 using the media sensor 14 to distinguish the type of paper, the user does not need to be aware of the type of paper when setting it. In view of this, the image forming apparatus 201 is provided with a mode (hereinafter, also referred to as an automatic media setting mode) for automatically setting print control parameters and the like that use this function.

On the other hand, the image forming apparatus 201 also provides a mode in which the user manually sets the type of paper to be used (hereinafter, also referred to as a manual media setting mode). By operating the instruction/display unit 13, the user can set in advance either an automatic media setting mode or a manual media setting mode for each paper feed cassette. Note that the default mode is the automatic media setting mode. A setting value indicating whether the setting mode is the automatic media setting mode or the manual media setting mode is stored in the RAM 12. Note that the above-described configuration of the media sensor 14 is merely an example, and the present disclosure is not limited to this configuration. For example, the media sensor 14 may be configured by combining an ultrasonic sensor such as a piezoelectric element in addition to a light emitting element and a light receiving element, or may have other configurations.

### User-Defined Paper Registration Method 1

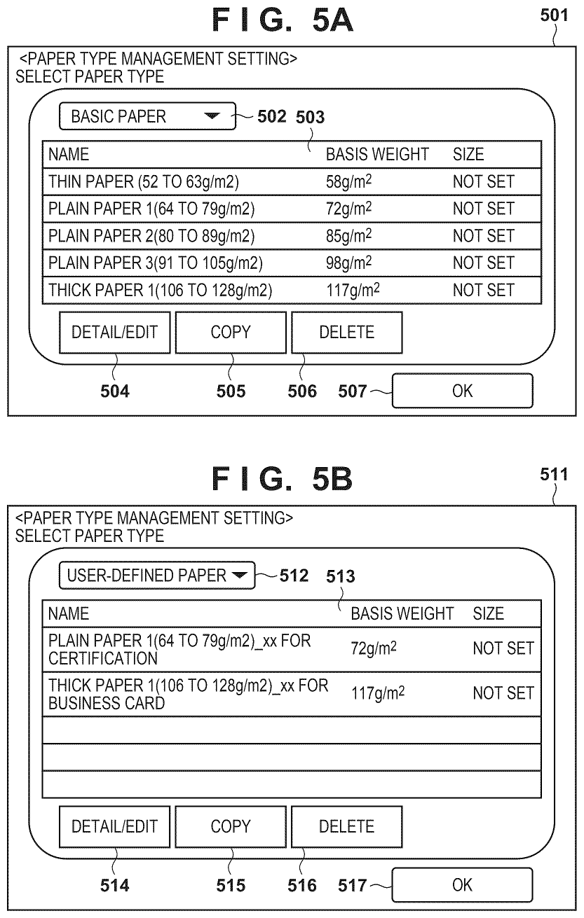

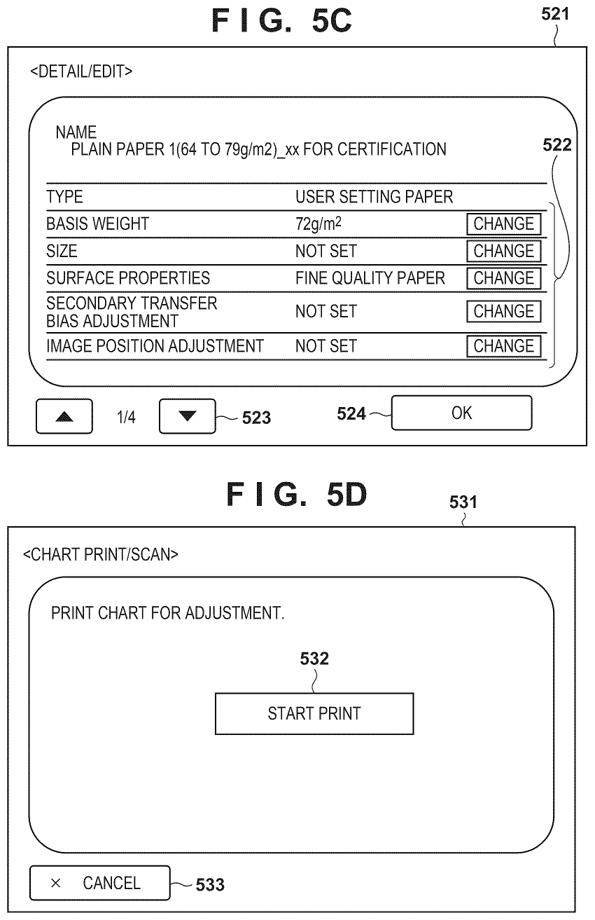

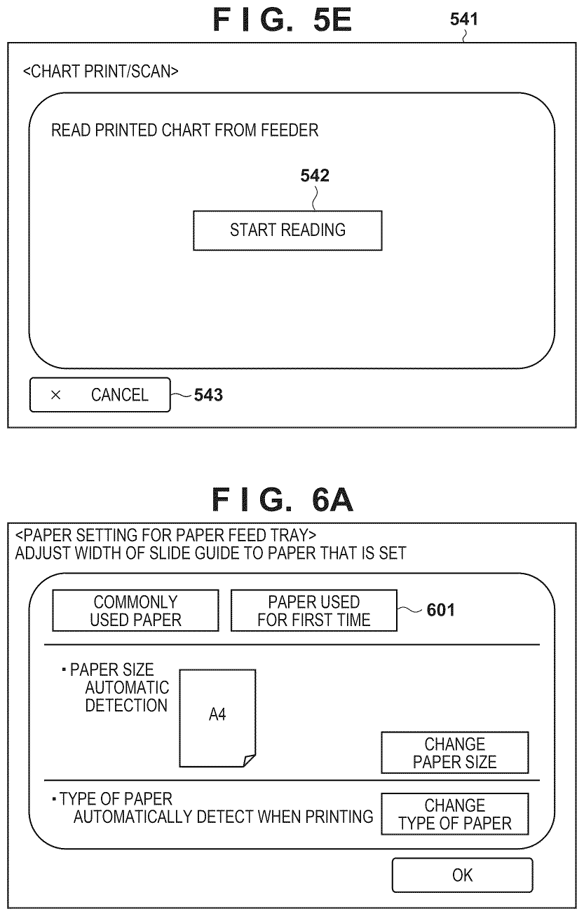

FIGS. 5A to 5E are diagrams that schematically show screens displayed on the instruction/display unit 13. A method for registering a user-defined paper will be described with reference to FIGS. 5A to 5E. The user-defined paper is different from the basic paper information prepared in advance, and is information on a type of paper that is uniquely set by the user. The user can then set features of the type of paper, such as basis weight and surface property, and set print control parameters (control parameters for image formation), such as the fixing temperature. In this embodiment, print control parameters for a basic paper that are stored in advance in a first storage region of the RAM 12 are used to create print control parameters for the user-defined paper. Then, the CPU 10 stores the print control parameters of the created user-defined paper in the first storage region of the RAM 12.

More specifically, the procedure by which the user selects the type of paper will be described first with reference to FIG. 5A. By touching a pull-down menu 502, the user can select one of three options, namely “basic paper”, “user-defined paper”, and “all”. Note that FIG. 5A shows an example in which the user selects the basic paper. The CPU 10 reads out the paper information stored in the RAM 12 in response to the selection and displays it in the form of a list 503. The user can register a user-defined paper by selecting any basic paper from the paper displayed in the list 503, touching a copy icon 505, and then inputting a new name. The user can also select any basic paper from the papers displayed in the list 503 and then touch a details/edit icon 504 to check and edit the details of the selected basic paper. Note that the display screen is set such that it will not respond even if a delete icon 506 is operated. With this setting, the registered information of the basic paper cannot be deleted.

FIG. 5B shows an example in which the user selects the user-defined paper in a pull-down menu 512, for example. In this case, a list 513 displays a list of user-defined papers that the CPU 10 has read out from the RAM 12. The user can register a new user-defined paper based on a previously-registered user-defined paper by selecting any user-defined paper from the papers displayed in the list 513 and then touching the copy icon 515. In addition, the user can select any user-defined paper from the paper displayed in the list 513 and then touch the details/edit icon 514 to check and edit print control parameters such as basis weight and size. The user can also select any user-defined paper from the paper displayed in the list 513 and then touch a delete icon 516 to delete the selected user-defined paper.

FIG. 5C is an example of a screen that is displayed when the details/edit icons 504 and 514 are touched. On such a screen, parameters required to control printing for each type of paper are displayed in the form of a list. In addition, a change icon is provided in the column of each parameter, and the parameter can be edited by touching this change icon. More specifically, in a “name” field, for a basic paper, the name that is registered in advance in the device is displayed, and for a user-defined paper, the name that the user registered is displayed. A “type” field displays the type of the paper selected by the user. A “basis weight” field indicates the weight per unit area of the paper. A “size” field displays the size of the paper. A “surface property” column displays the type of paper, which indicates features of the surface shape of the paper.

### Adjustment of Print Control Parameters

Furthermore, “secondary transfer bias” displayed on the screen of FIG. 5C is a value with a magnitude necessary for transferring the toner on the intermediate transfer body, and is set to a value with a magnitude that does not cause abnormal discharging. For example, if paper whose moisture content or resistance value is significantly different from a standard value is used for printing, there is a possibility that the default value of the secondary transfer bias will not be sufficient for optimal transfer. In view of this, in such a case, the secondary transfer bias is set to a value different from the default value. In addition, if the resistance value of the paper used for printing is greater than the standard value, there is a possibility that the secondary transfer bias will be insufficient with the default value. In view of this, in such a case, the secondary transfer bias is set to a value larger than the default value. In addition, if the moisture content of the paper used for printing is smaller than a standard value, abnormal discharging is likely to occur, which may result in poor image quality. In view of this, in such a case, the secondary transfer bias is set to a value smaller than the default value. In this way, the secondary transfer bias needs to be set and adjusted to an appropriate value depending on the type of paper used for printing.

In view of this, in the image forming apparatus 201, a coarse adjustment chart or fine adjustment chart (not shown) is printed in order to set and adjust the secondary transfer bias of the print sheet, and these charts are read by the image reading apparatus 202. In this manner, the adjustment value of the secondary transfer bias is determined such that the transfer efficiency falls within a specified range. More specifically, when the user wishes to newly register or re-register adjustment of the secondary transfer bias, the user touches the change icon 522 (FIG. 5C) in the field displaying “secondary transfer bias”. The display then transitions to the chart print screen shown in FIG. 5D. When a print start icon 532 is touched, the CPU 10 prints a chart and displays the screen of FIG. 5E. The user places the printed chart in the feeder and presses a reading start icon 542. The CPU 10 then scans the chart, calculates the necessary adjustment values, and stores the adjustment values in the RAM 12 in association with the user-defined paper selected in FIG. 5B. When the adjustment value is stored, the display of “not set” for “secondary transfer bias adjustment” on the detail display screen 521 shown in FIG. 5C is changed to “set”.

In addition, “image position adjustment” displayed on the screen of FIG. 5C is an adjustment item for adjusting the image position on each of the front and back sides of the paper. That is, in adjusting the image position, adjustment values for the image position with respect to the top and left ends on each of the front and back sides are set as movement amounts. For this adjustment as well, the CPU 10 prints a chart for adjusting the image positions on the front and back sides. The user places the printed chart in the feeder and presses a reading start icon 542. The CPU 10 then scans this chart, calculates the necessary adjustment values, and stores the adjustment values in the RAM 12 in association with the user-defined paper selected in FIG. 5B. When the adjustment value is saved, the display of “not set” for “image position adjustment” on the detail display screen 521 shown in FIG. 5C is changed to “set”.

Note that on the screen of FIG. 5C, basis weight, size, surface property, secondary transfer bias adjustment, and image position adjustment are displayed as examples of print control parameters, but various other parameters are also set. Other parameters are displayed on a screen to which a transition occurs when an arrow icon 523 shown in FIG. 5C is touched. The other parameters include, for example, toner amount adjustment and margin adjustment. In this way, the basic paper or user-defined paper is selected and the copy icons 505 and 515 are touched, whereby the user-defined paper and its print control parameters can be easily registered.

### User-Defined Paper Registration Method 2

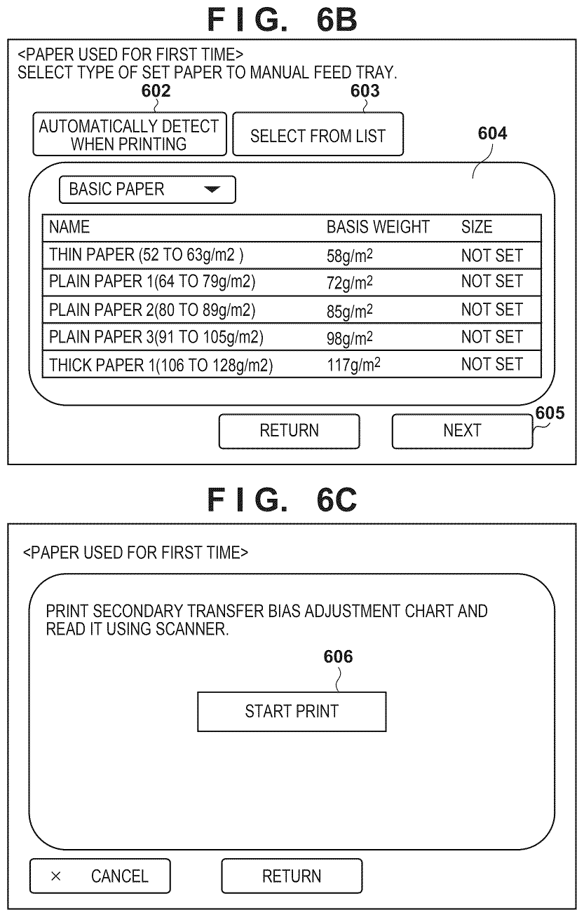

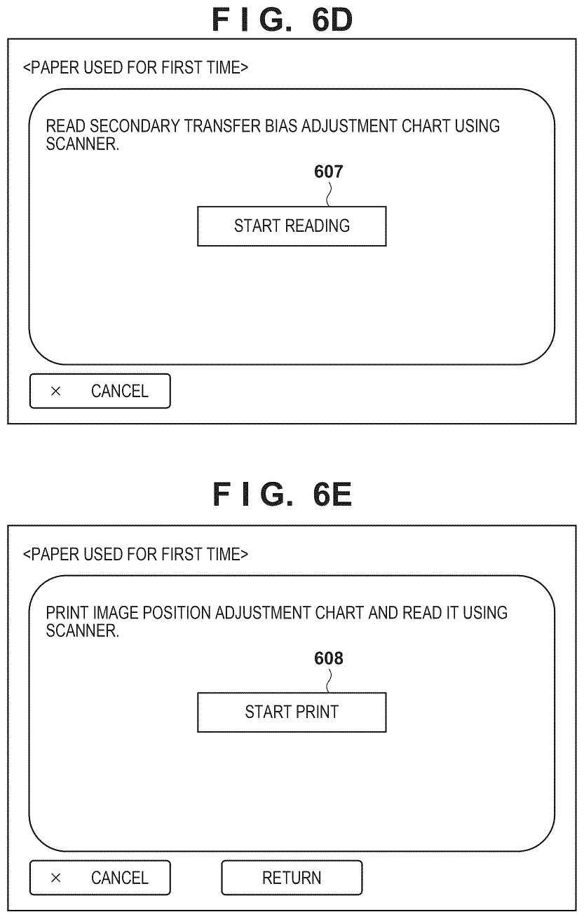

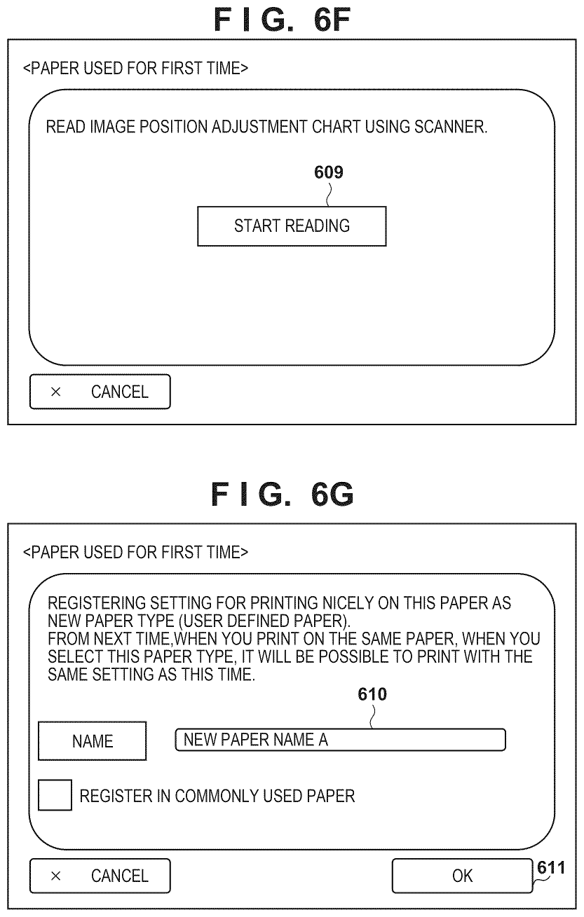

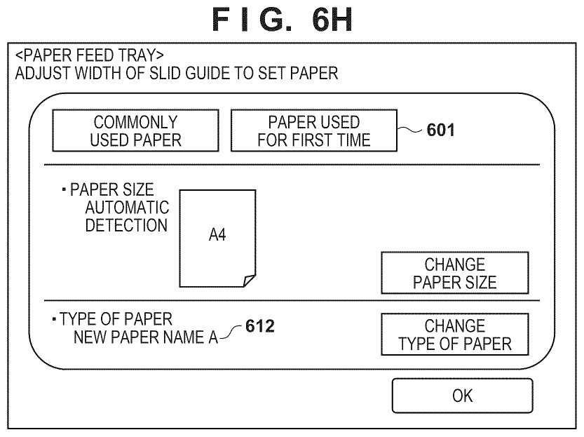

Another example of a method for registering a user-defined paper will be described with reference to FIGS. 6A to 6H. This method uses the media sensor 14 to allow the user to register a user-defined paper without being aware of the type of paper. FIG. 6A is an example of a setting screen that the CPU 10 displays on the operation panel 205 when the CPU 10 detects that paper has been placed in the paper feed tray. On this screen, the user can perform setting operations such as setting the size and type of paper placed in the paper feed tray. More specifically, when a “paper used for the first time” icon 601 is touched on the screen in FIG. 6A, a flow for creating a user-defined paper starts, and the display screen transitions to the screen in FIG. 6B. The screen in FIG. 6B displays a screen for selecting a type of paper serving as a base for registering a user-defined paper. Note that the type of paper serving as a base has already been registered in the image forming apparatus 201 as a print sheet, with parameters set for the type of paper serving as a base. When an “automatically detect when printing” icon 602 is touched on the screen, the type of paper is automatically detected using the media sensor 14, and subsequent registration of a user-defined paper is performed according to the detected type of paper.

On the other hand, when a “select from list” icon 603 is touched on the screen of FIG. 6B, the user can select a type of paper serving as a base from a paper type list 604 displayed on the screen. Note that the paper type list 604 is an example of a “list displaying the print sheet that has already been set in a selectable manner for each type of the print sheet”. Then, when a “next” icon 605 (an example of a “fourth object” in the present disclosure) is touched with a predetermined type of paper selected, the screen transitions to a secondary transfer bias adjustment screen in FIG. 6C.

On the screen of FIG. 6C, when a print start icon 606 is touched, a chart for adjusting the secondary transfer bias is printed. Here, if the “automatically detect when printing” icon 602 has been selected on the screen of FIG. 6B, when the first sheet of paper is fed on which the secondary transfer bias adjustment chart is printed, the paper is measured by the media sensor 14 and the type of paper is distinguished. The CPU 10 copies the distinguished type of paper and registers it in the paper type database as a user-defined paper. At this point, the CPU 10 stores, among the measurement data measured by the media sensor, data such as basis weight and surface property, as print control parameters for the user-defined paper in the RAM 12.

After printing the adjustment chart for the secondary transfer bias based on the stored print control parameters for the user-defined paper, the CPU 10 transitions the screen to the screen in FIG. 6D. The screen that is the transition destination displays a message instructing the start of reading of the printed secondary transfer bias adjustment chart. When a reading start icon 607 on the screen is touched, the CPU 10 reads the secondary transfer bias adjustment chart and calculates the adjustment value. The CPU 10 stores the calculated adjustment values in the RAM 12 as print control parameters for the user-defined paper. Thereafter, the CPU 10 prints and scans the image position adjustment chart in the same manner as the secondary transfer bias adjustment chart (FIGS. 6E and 6F), calculates adjustment values, and stores the calculated adjustment values in the RAM 12 as print control parameters for the user-defined paper.

Note that the print control parameters are not limited to the adjustment of the secondary transfer bias and the image position adjustment, and may be any parameters that can be implemented in association with the paper. In addition, adjustment of these plurality of print control parameters can be performed all at once in the flow for registering the user-defined paper. Also, although an example is shown in which both the secondary transfer bias adjustment and the image position adjustment are performed, there are cases in which each adjustment is possible/impossible depending on the size and type of paper. In this case, the CPU 10 automatically determines the necessary adjustments depending on the size and type of paper, and performs screen display control for secondary transfer bias adjustment and image position adjustment. However, when the “automatically detect when printing” icon 603 is touched on the paper type selection screen shown in FIG. 6B, the paper is automatically measured by the media sensor 14 when it is fed to print the secondary transfer bias adjustment chart, and the type of paper is distinguished. In addition, the CPU 10 may control each constituent portion so as to feed only one sheet before adjustment is performed and then determine the adjustment menu to be performed thereafter.

Next, the CPU 10 transitions the screen to the screen shown in FIG. 6G. The name of the user-defined paper can be input on the screen that is the transition destination. The user inputs any name in a name input field 610 and touches an OK icon 611. Then, the CPU 10 changes the name of the user-defined paper in the paper type database to the name input in FIG. 6G, and transitions the screen to the screen in FIG. 6H. In this way, the registration of the user-defined paper is completed. Note that FIG. 6H is the same paper setting screen for the paper feed tray as in FIG. 6A, but the name of the user-defined paper registered in the user-defined paper registration flow is displayed in a region 612 where the type of paper is displayed.

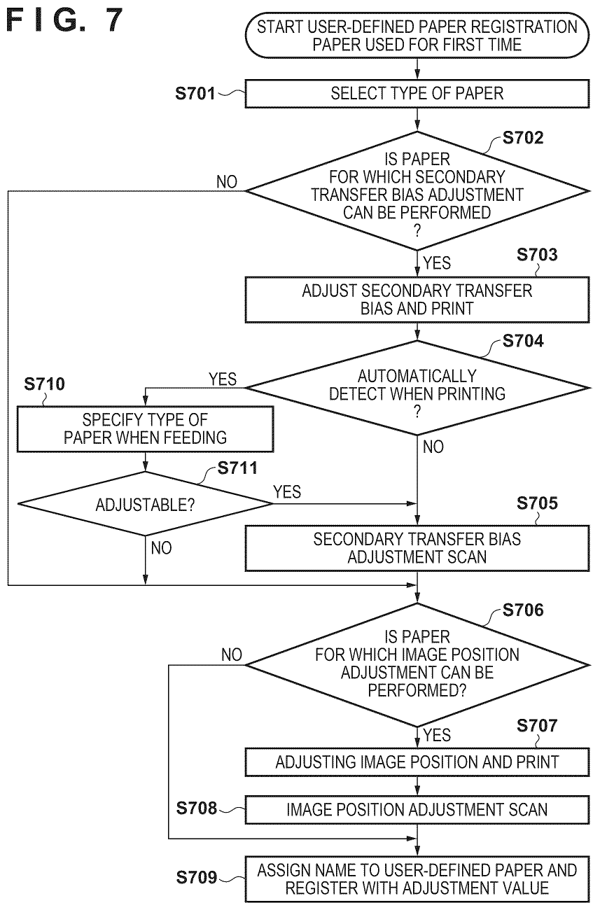

The control flow for registering the above-mentioned user-defined paper will be described with reference to FIG. 7. Each step in the flowchart of FIG. 7 is realized by the CPU 10 reading out the control program from the ROM 11, loading it into the RAM 12, and executing it. Note that before the processing of this flowchart starts, the CPU 10 detects that paper has been placed on the manual feed tray 5. Then, the CPU 10 displays the paper setting screen (FIG. 6A) including the “paper used for the first time” icon 601, and this icon 601 is touched.

In step S701, the CPU 10 accepts the selection of the type of paper to be copied in order to register the user-defined paper. The type of paper to be copied is automatically set when the “automatically detect when printing” icon 602 in FIG. 6B is selected, and is selected from a paper type list 604 when the “select from list” icon 603 is touched. Then, the CPU 10 accepts a touch of the “next” icon 605 and proceeds to step S702.

In step S702, the CPU 10 determines whether or not the type of paper selected from the paper type list 604 in step S701 is a type of paper for which secondary transfer bias adjustment can be performed. If the CPU 10 determines that this is not possible, the adjustment of the secondary transfer bias is skipped and the processing proceeds to step S706. On the other hand, if the CPU 10 determines that it is possible, the processing proceeds to step S703. In addition, if the “automatically detect when printing” icon 602 has been selected in step S701, the processing automatically proceeds to step $703. In step S703, the CPU 10 displays a print screen for adjusting the secondary transfer bias (FIG. 6C), starts printing upon accepting a touch of the print start icon 606, and proceeds to step S704.

In step S704, the CPU 10 determines whether or not the “automatically detect when printing” icon 602 was touched in step S701. If the CPU 10 determines that it was touched, the processing proceeds to step S710. In step S710, the CPU 10 measures paper type data such as basis weight and surface property using the media sensor 14 when the paper is fed, and compares the measured data with paper type data stored in the RAM 12 to specify the type of paper. In step S711, the CPU 10 determines whether or not the print adjustment parameters of the specified type of paper are adjustable. Note that this determination may be performed using a variable stored in the RAM 12 that indicates whether or not the paper is one for which print adjustment parameters can be adjusted. If the CPU 10 determines that adjustment is possible, the processing proceeds to step S705. If the CPU 10 determines that adjustment is not possible, the adjustment of the secondary transfer bias in step S705 is skipped and the processing proceeds to step S706. On the other hand, if the CPU 10 determines in step S704 that the “automatically detect when printing” icon 602 has not been touched, the processing proceeds directly to step S705 without proceeding to step S710 and step S711.

In step S705, the CPU 10 displays a scan screen for adjusting the secondary transfer bias, reads a print chart (FIG. 6D), calculates an adjustment value, and proceeds to step S706. In step S706, the CPU 10 determines whether or not the type of paper of the copy source is a type of paper for which image position adjustment can be performed. If the CPU 10 determines that the paper is suitable for image position adjustment, the processing proceeds to step S707. On the other hand, if the CPU 10 determines that image position adjustment cannot be performed, the processing proceeds to step S709 without proceeding to steps S707 and S708. In step S707, the CPU 10 prints a chart for adjusting the image position (FIG. 6E). In step S708, the CPU 10 reads the printed image position adjustment chart (FIG. 6F) and calculates the adjustment values. In step S709, the CPU 10 displays the screen in FIG. 6G and accepts input of the name of the user-defined paper. Then, the CPU 10 stores the name of this input user-defined paper, the adjustment value for the secondary transfer bias, and the adjustment value for the image position adjustment in association with each other in the RAM 12. Then, the series of processing ends.

### Adjustment of Parameters for Registered User-Defined Paper

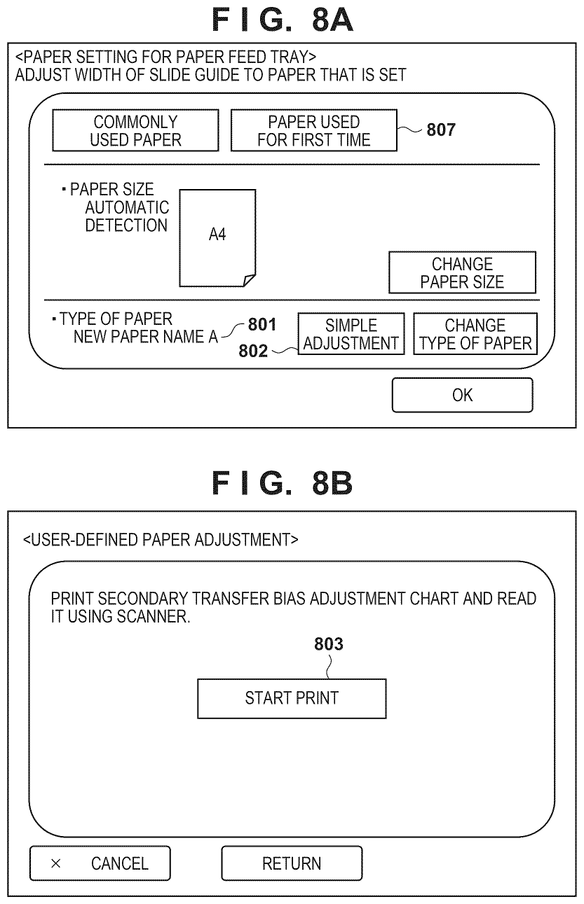

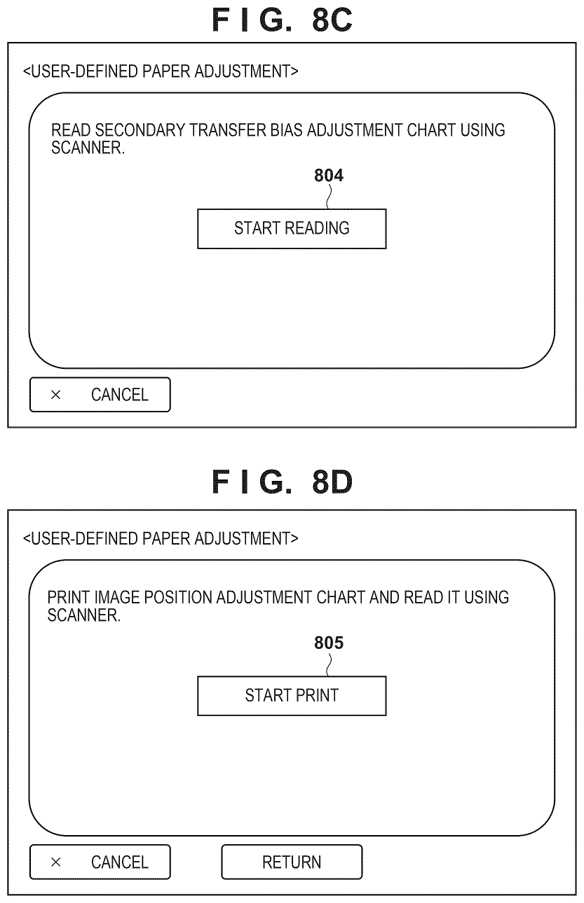

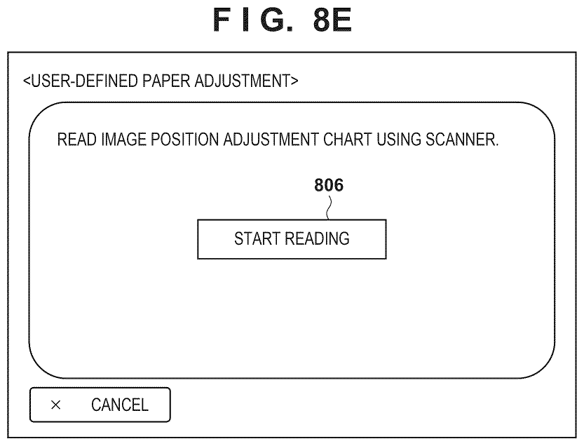

Processing in which the user adjusts the parameters of the registered user-defined paper again after the user has registered the user-defined paper will be described with reference to FIGS. 8A to 8E. Note that FIG. 8A is an example of an adjustment screen that the CPU 10 displays on the operation panel 205 when the CPU 10 detects that paper has been placed in the paper feed tray and further determines that the detected type of paper is a user-defined paper.

The CPU 10 determines whether or not parameters relating to the secondary transfer bias and image position adjustment have already been stored in the RAM 12 in association with the corresponding print sheet. If the CPU 10 determines that these parameters have already been stored in the RAM 12, the CPU 10 displays the name of the registered user-defined paper and a simple adjustment icon 802 in a region 801 on the screen of FIG. 8A. Also, in FIG. 8A, a “paper used for the first time” icon 807 is displayed, similarly to the screen in FIG. 6A. When this “paper used for the first time” icon 807 (an example of the “second object” in this disclosure) is touched, a flow for creating a user-defined paper is started, and the display screen transitions to the screen in FIG. 6B (an example of the “third screen” in this disclosure).

Note that the screen in FIG. 8A is an example of a “first screen” in the present disclosure, and the simple adjustment icon 802 is an example of a “first object” in the present disclosure. Note that these determination processes are examples of “determining” in the present disclosure. When the simple adjustment icon 802 is touched, the CPU 10 transitions the display screen to a secondary transfer bias adjustment screen in FIG. 8B (an example of the “second screen” in the present disclosure). When a print start icon 803 (an example of a “third object” in the present disclosure) is touched on the screen of FIG. 8B, the CPU 10 prints a chart for adjusting the secondary transfer bias. Then, the CPU 10 transitions the screen to that of FIG. 8C.

When the reading start icon 804 is touched on the screen of FIG. 8C, the CPU 10 reads the secondary transfer bias adjustment chart and calculates the adjustment value. Then, the CPU 10 stores the calculated adjustment values in the RAM 12 as print control parameters for the user-defined paper. Thereafter, on the screens shown in FIGS. 8D and 8E, the same touch operation as that on the screens shown in FIGS. 8B and 8C is performed. Then, the image position adjustment chart is printed, scanning is performed, the adjustment values are calculated, and the image position adjustment values are stored. Note that the screens in FIGS. 8B to 8E may be the same as the screens in FIGS. 6C to 6F.

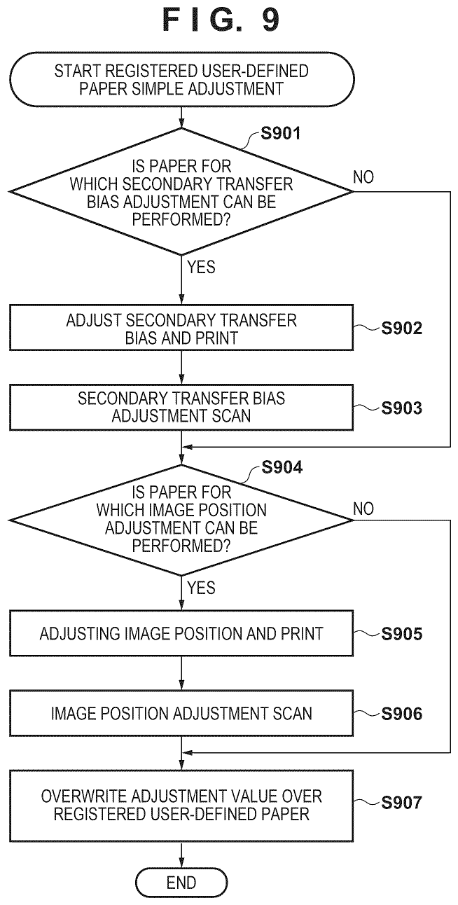

Next, a control flow for adjusting parameters of the registered user-defined paper will be described with reference to FIG. 9. Note that this flowchart is executed by the CPU 10 reading out a control program from the ROM 11 and loading it into the RAM 12. This flowchart begins when the CPU 10 detects that paper has been placed in the paper feed tray, displays the paper setting screen (FIG. 8A), determines that the type of paper is a registered user-defined paper, and touches the simple adjustment icon 802.

In step S901, the CPU 10 determines whether or not the type of paper is a type for which adjustment of the secondary transfer bias can be performed. If the CPU 10 determines that it is a type of paper for which adjustment can be performed, the processing proceeds to step S902. On the other hand, if the CPU 10 determines that it is a type of paper for which adjustment cannot be performed, steps S902 and S903 are skipped and the processing proceeds to step S904. In step S902, the CPU 10 displays a print screen (FIG. 8B) for adjusting the secondary transfer bias, and when the print start icon 803 is pressed, feeds paper and starts printing. In step S903, the CPU 10 displays the scan screen (FIG. 8C) for adjusting the secondary transfer bias, and in response to the reading start icon 804 being touched, executes reading of the print chart and calculates new adjustment values.

In step S904, the CPU 10 determines whether or not the type of paper is a type of paper for which image position adjustment can be performed. If the CPU 10 determines that it is a type of paper for which adjustment can be performed, the processing proceeds to step S905. On the other hand, if the CPU 10 determines that it is a type of paper for which adjustment cannot be performed, steps S905 and S906 are skipped and the processing proceeds to step S907. In step S905, the CPU 10 displays a print screen (FIG. 8D) for the chart for adjusting the image position, and executes printing of the chart for adjusting the image position in response to the print start icon 805 being touched. In step S906, the CPU 10 displays the scanning screen (FIG. 8E) for adjusting the image position, and in response to the reading start icon 806 being touched, reads the chart for adjusting the image position and calculates new adjustment values. In step S907, the CPU 10 stores the calculated new adjustment value of the secondary transfer bias and the adjustment value of the image position adjustment in the RAM 12 (an example of “updating a parameter” in the present disclosure). Then, the series of processing ends. Note that the CPU 10 executing the processing from steps S901 to S907 is an example of “adjusting” in the present disclosure.

### Operations and Effects

According to the image forming apparatus 201, when a user-defined paper has been registered, a simple adjustment icon 802 is displayed on the above-described paper feed setting screen (FIG. 8A). If an image defect, misalignment, or the like occurs, when the user touches this simple adjustment icon 802, the above-described guidance screen for adjusting the secondary transfer voltage and the guidance screen for adjusting the image position are sequentially displayed (FIGS. 8B to 8E). Accordingly, even a general user can easily adjust the print control parameters that have already been set. Accordingly, the user can prevent deterioration of the quality of the printed matter. This allows the user to continuously maintain a high quality of printed matter.

In addition, according to the image forming apparatus 201, the CPU 10 automatically determines whether or not the voltage for secondary transfer can be adjusted and whether or not the image position can be adjusted depending on the type of paper. In addition, according to the image forming apparatus 201, the media sensor 14 can automatically detect the type of paper. This increases the likelihood that a typical user will be able to appropriately set and adjust print control parameters.

According to the image forming apparatus 201, when a user-defined paper is not registered, the user touches the icon of “paper used for the first time” on the paper feed setting screen (FIG. 6A). Upon doing so, the user can select the paper that will serve as the base for the user-defined paper on the screen that is the transition destination (FIG. 6B). Furthermore, with the paper serving as the base for the user-defined paper selected, the “next” icon 605 is touched. Then, guidance screens (FIGS. 6C and 6D) for guiding the adjustment of the secondary transfer voltage and guidance screens (FIGS. 6E and 6F) for guiding the adjustment of the image position are sequentially displayed. By following this series of screen transitions, the user can easily set new print control parameters for an unregistered user-defined paper. Thus, even a general user can create high-quality printed matter.

### Modified Examples

In the above embodiment, the image position is adjusted after the secondary transfer bias is adjusted, but the order may also be reversed. Also, adjustment of the secondary transfer bias and image position adjustment are described as examples of parameter adjustment, but the image forming apparatus 201 includes other adjustment menus, and similarly, necessary adjustments can be determined and implemented according to the type of paper. Note that when registering a user-defined paper, if it is determined in step S711 that the secondary transfer bias cannot be adjusted, the processing of step S709 may not be executed and the flow for registering the user-defined paper may be stopped. Also, if both the secondary transfer bias and the image position adjustment are not adjustable, the processing of step S709 may not be executed and the flow for registering the user-defined paper may be stopped.

In addition, the CPU 10 may determine whether or not the registered user-defined paper allows adjustment of the secondary transfer bias and image position adjustment, and if the CPU 10 determines that neither is adjustable, the simple adjustment icon 802 may be hidden (FIG. 8A). Note that this determination may be performed depending on the type of paper. The type of paper may also be automatically detected by the media sensor 14. Note that hiding the simple adjustment icon 802 in this manner is an example of “determining that the first object is not to be included in the first screen if the parameter cannot be set” in the present disclosure.

The image forming apparatus 201 may include a communication module that includes a network interface card (NIC), a wireless circuit, and the like, and is capable of communicating with an external device (e.g., a user terminal). The communication module may then transmit screen information displayed on the instruction/display unit 13 to an external device, and receive instructions to register a user-defined paper and set and adjust print control parameters from the external device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-123433, filed Jul. 30, 2024, which is hereby incorporated by reference herein in its entirety.

What is claimed is:

1. An image forming apparatus comprising:
one or more memory devices that store a set of instructions; and
one or more processors that execute the set of instructions to:
output a first screen on which a print sheet can be set, and a second screen for setting a parameter for controlling driving of an image forming apparatus corresponding to a type of the print sheet; and
determine whether or not a first object for transitioning from the first screen to the second screen is to be included in the first screen,
wherein it is determined that the first object is to be included in the first screen if the print sheet for which the parameter has already been set is present.

2. The image forming apparatus according to claim 1,
wherein the first screen includes a second object for transitioning to a third screen including a list displaying the print sheet that has already been set in a selectable manner for each type of the print sheet.

3. The image forming apparatus according to claim 1,
wherein the one or more processors further execute instructions in the one or more memory devices to:
determine that the first object is not to be included in the first screen if the type of the print sheet is a type for which the parameter cannot be set.

4. The image forming apparatus according to claim 3,
wherein the type of the print sheet is specified using an amount of reflected light detected by a sensor having a light emitting portion and a light receiving portion, the reflected light having been emitted from the light emitting portion, reflected by the print sheet, and received by the light receiving portion.

5. The image forming apparatus according to claim 1,
wherein the second screen includes a third object for starting printing of information relating to the parameter.

6. The image forming apparatus according to claim 5,
wherein the one or more processors further execute instructions in the one or more memory devices to:
accept an operation on an object included in a displayed screen;
adjust the parameter; and
when an operation on the third object is accepted, if the parameter can be set, print information relating to the parameter on the print sheet, read the printed print sheet, and update the parameter corresponding to the type of the print sheet using the information relating to the parameter printed on the read print sheet.

7. The image forming apparatus according to claim 2,
wherein the third screen includes a fourth object for transitioning to the second screen for setting the parameter corresponding to the selected print sheet.

8. The image forming apparatus according to claim 1,
wherein the parameter includes at least one of a secondary transfer bias and a position of an image to be printed on the print sheet.

9. A control method for an image forming apparatus, comprising:
outputting a first screen on which a print sheet can be set, and a second screen for setting a parameter for controlling driving of an image forming apparatus corresponding to a type of the print sheet; and
determining whether or not a first object for transitioning from the first screen to the second screen is to be included in the first screen,
wherein it is determined that the first object is to be included in the first screen if the print sheet for which the parameter has already been set is present.

10. A non-transitory computer-readable storage medium storing a program for causing a computer to execute each step of a control method for an image forming apparatus, the control method comprising:
outputting a first screen on which a print sheet can be set, and a second screen for setting a parameter for controlling driving of an image forming apparatus corresponding to a type of the print sheet; and
determining whether or not a first object for transitioning from the first screen to the second screen is to be included in the first screen.
wherein it is determined that the first object is to be included in the first screen if the print sheet for which the parameter has already been set is present.
